(19) United States
(12) Patent Application Publication
(10) Pub. No.: US 2001/0025330 A1
(43) Pub. Date: Sep. 27, 2001

(54) Interface having plug and play function

(76) Inventors: Kenji OI, Kasugai-shi (JP); Hiroyuki Tsujimoto, Kasugai-shi (JP)

Correspondence Address: STAAS & HALSEY, Suite 500, 700 Eleventh Street, N.W., Washington, DC, 20001, US

(21) Appl. No.: 09/734,704

(22) Filed: Dec. 13, 2000

(30) Foreign Application Priority Data
Mar. 24, 2000 (JP) 2000-083911
Mar. 29, 2000 (JP) 2000-091942

(51) Int. Cl. G06F 13/00; G06F 13/38

(52) U.S. Cl. 710/129

(57) ABSTRACT

An interface circuit having a plug and play function executes a predetermined bus reset sequence in response to a bus reset. During execution, the circuit analyzes relevant data to determine whether an error has occurred. If so, it deletes the information and re-issues the bus reset to re-execute the bus reset sequence. If an error has not occurred, the interface notifies the host controller and supplies it with the relevant data. Because the host controller is notified only if the reset sequence is executed successfully, the application software and the device driver do not process errors. Thus the interface prevents a detected abnormality from affecting the network.

### BACKGROUND OF THE INVENTION

The present invention relates to an interface, particularly, to an interface having a plug and play function and self-diagnosis of an interface.

A personal computer is connected to peripheral devices, such as a digital video camera or a color page printer, by an interface complying with, for example, the IEEE 1394 standard. Data is transferred through the interface. The interface is provided with a plug and play function to enable connection (plug-in) and disconnection (plug-out) of a device when data is being communicated between devices. Specifically, when a device is newly connected to a port (socket) of an interface, the interface notifies the associated network of a bus reset. The interface of each device connected to the network performs a predetermined bus reset sequence in response to the bus reset to recognize every device connected to the network and reconfigure a network topology.

An IEEE 1394 interface of a personal computer (PC) is in compliance with the open host controller interface (OHCI) protocol. The interface stores a packet (ID packet) in an internal buffer memory and simultaneously transfers the packet to a microprocessor unit (MPU) of the PC. The packet is used to recognize changes in the plug status (plug-in and plug-out) of a serial bus and to recognize the received or transmitted topology.

When a bus reset occurs due to a topology change, the interface transfers a data packet indicating the initialization of the topology and an ID packet of each device to the MPU. The MPU sets a device driver and an application program in accordance with the information of the transferred packets. This enables the PC to recognize the devices configuring the topology.

The plug and play function requires continuous and consistent information from when the topology initialization is started to when the topology initialization is completed, which is reported by the transfer of the ID packets. The transmission and receipt of this information differs from the transmission and receipt of the packets that include all of the necessary information.

However, when a problem in the serial bus or another device causes the interface to receive a packet or data that is erroneous, the interface further transfers the erroneous packet or data. Further, when the interface itself generates the topology initialization information (bus reset sequence), all of the topology initialization information is stored in a buffer memory in real time and transferred from the buffer memory to the MPU whenever necessary. Thus, if a bus reset is issued and then a further bus reset is issued, the information provided to the MPU prior to the new bus reset is not needed. Accordingly, driver software and various application software are required to evaluate and analyze the provided information and take the proper procedures accordingly. However, the recognition of an information error value or an error originating location is impossible. Thus, it is difficult for the MPU to predict every kind of situation to cope with such error. As a result, the driver software and various application software does not process errors even if the data provided to the MPU includes abnormal data, lacks information, or is erroneous. This leads to time-out or erroneous functioning and causes a hangup of the software or the entire system.

An interface provided with a hot plug function is also required to have a measure to counter malfunctions. This is because when a device having a malfunctioning interface is connected to a network, the malfunctioning interface affects the entire network. For example, when a device is newly connected to an IEEE 1394 interface, a bus reset is issued and data transfer is temporarily interrupted. Hence, a malfunctioning interface may repetitively issue the bus reset and require a long period of time until the bus reset is completed by time-out. During this period, the transmission of data is interrupted. The repetition of the bus reset also occurs when an abnormal connection cable is used or when a device is malfunctioning.

If a malfunctioning device causes an abnormality in a network, it is difficult to locate the malfunctioning device. This is because the connection procedure is unstable. Thus, each device must be disconnected from the network to locate the malfunctioning device. However, this takes time. Further, even if the malfunctioning device is located, the location of the abnormality cannot be confirmed.

### SUMMARY OF THE INVENTION

It is a first object of the present invention to provide an interface for preventing the transfer of erroneous information during bus reset.

It is a second object of the present invention to provide an interface that prevents an abnormal interface from affecting the network.

These objects and advantages are attained by an interface or interface system that has a plug and play function and that is connected to a host controller. When an external bus changes status, the plug and play function generates a bus reset that causes the interface to perform a predetermined bus reset sequence. The interface system contains an analysis circuit that analyzes data from the external bus during the bus reset sequence to determine whether the sequence has been completed normally. If so, the analysis circuit provides the data to the host controller. If it detects an abnormality, the analysis circuit generates a bus reset, preferably after providing the host controller with an interrupt event and other necessary data.

The analyzed data preferably includes a packet provided from an external node via the external bus. The packet is analyzed to determine whether the bus is functioning normally. The data can also include information indicating a change in the status of the external bus. The analysis circuit then determines whether the information corresponds to the bus reset sequence.

Data provided from the external bus is stored in a buffer memory by the analysis circuit either during or before data analysis, which occurs after completion of the bus reset sequence. The system preferably also includes a port circuit for detecting the status of the external bus and generating associated detection information; a physical layer circuit connected to the port circuit to receive data via the port circuit and to generate a data packet; a link layer circuit connected to the physical layer circuit to determine whether the data packet is addressed to the interface system; and a buffer memory connected to the link layer circuit to store the detection information and the data packet.

The present invention also provides an interface having a self-diagnosis circuit. The interface performs a predetermined connection procedure, such as a bus reset sequence, with a network, however, if the circuit generates a diagnosis indicating an abnormality of the interface, transition to the procedure is terminated. The diagnosis may include information such as the location of the abnormality. The self-diagnosis circuit preferably determines whether the status of the interface satisfies a predetermined self-diagnosis initiation requirement, and then initiates the self-diagnosis when the requirement is satisfied.

In some cases, when an abnormality is indicated, the interface stops operation of a part of the interface that does not transfer data with the network, but continues to perform self-diagnosis after performing the connection procedure. In other cases, operation of the interface is stopped.

To perform the connection procedure and transfer data to the network, the interface preferably also has a data transfer control circuit that includes first and second ports that are connected to the network and to transmitting and receiving circuits. In this case, the self-diagnosis circuit connects the first and second ports to each other and tests the data transfer control circuit using data transferred from the transmitting circuit to the receiving circuit via the first and second ports. For example, the testing can be a direct current characteristic test, an alternating current characteristic test, or a data transfer test.

The invention also provides a self-diagnosis method employed by the interfaces and interface systems described above.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of a system according to a first embodiment of the present invention;

FIG. 2 is a schematic block diagram of a computer of the system shown in FIG. 1;

FIG. 3 is a schematic block diagram of an interface of the computer shown in FIG. 2;

FIG. 4 is a schematic block diagram of an analysis unit of the interface shown in FIG. 3;

FIG. 5 is a schematic block diagram of a decoder output analysis circuit of the analysis unit shown in FIG. 4;

FIG. 6 is a schematic block diagram of a packet analysis circuit of the analysis unit shown in FIG. 4;

FIG. 7 is a chart illustrating the information stored in a memory of the interface shown in FIG. 3;

FIG. 8 is a flowchart illustrating an analysis process performed by the analysis unit of FIG. 4;

FIGS. 9(a) to 9(c) are charts illustrating the information stored in the memory of the interface shown in FIG. 3 during the analysis process;

FIGS. 10(a) to 10(c) are charts illustrating the information stored in the memory of the interface shown in FIG. 3 during the analysis process;

FIG. 11 is a schematic block diagram of a system according to a second embodiment of the present invention;

FIG. 12 is a schematic block diagram of a computer of the system shown in FIG. 11;

FIG. 13 is a flowchart illustrating a self-diagnosis process performed by the computer of FIG. 12;

FIG. 14 is a flowchart illustrating a self-diagnosis process performed when a bus abnormality is detected;

FIG. 15 is a schematic block diagram of an interface of the computer shown in FIG. 12;

FIG. 16 is a schematic block diagram of the interface of the computer shown in FIG. 12;

FIGS. 17(a) to 17(c) are schematic block diagrams of the interface of the computer shown in FIG. 12;

FIG. 18 is a flowchart illustrating a self-diagnosis process shown in the flowchart of FIG. 13;

FIG. 19 is a flowchart illustrating a direct current characteristic testing process shown in the flowchart of FIG. 18;

FIG. 19 is a flowchart illustrating a direct current characteristic testing process shown in the flowchart of FIG. 18;

FIG. 20 is a flowchart illustrating an alternating current characteristic testing process shown in the flowchart of FIG. 18; and

FIG. 21 is a flowchart illustrating an interface internal transfer process shown in the flowchart of FIG. 20.

### DETAILED DESCRIPTION OF THE PREFERRED EMBODMENTS

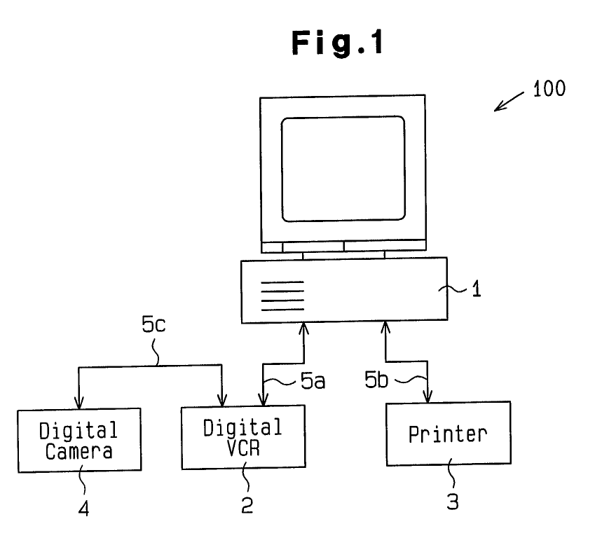

FIG. 1 is a schematic block diagram of a system 100 according to a first embodiment of the present invention. The system 100 employs IEEE 1394 interfaces to transfer data.

The system 100 includes a personal computer 1, a digital VCR 2, a printer 3, and a digital camera 4. The devices 1-4 are each provided with an IEEE 1394 interface to transfer data. Further, the devices 1-4 are connected to one another by bus cables 5a, 5b, 5c to form a network. The interface of each device functions as a node of the network.

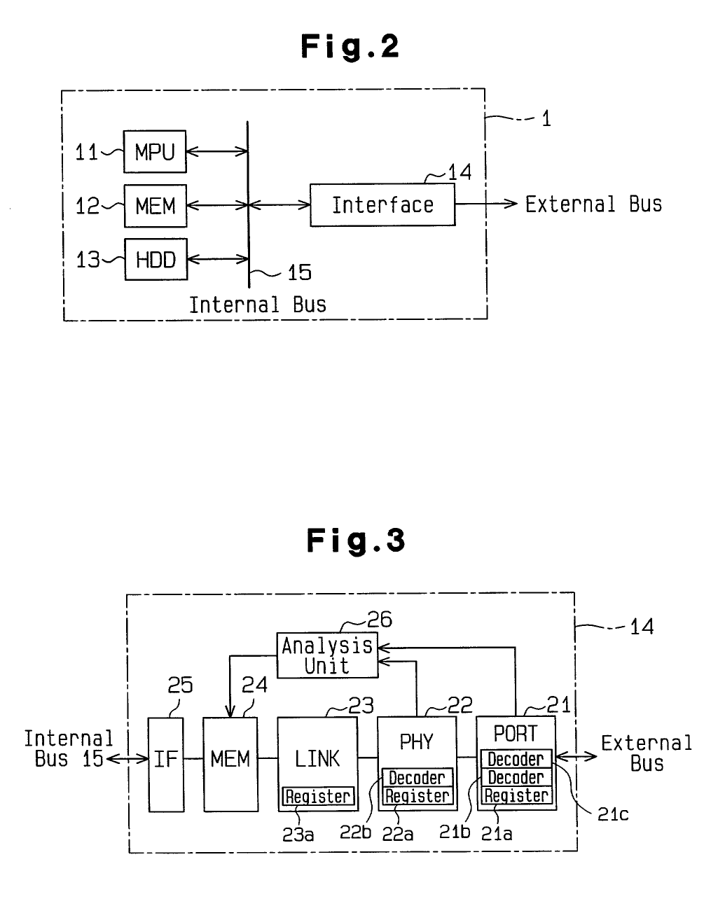

FIG. 2 is a schematic block diagram of the computer 1.

The computer 1 includes a microprocessor unit (MPU) 11, a memory (MEM) 12, which functions as a main memory, a hard disk drive (HDD) 13, which functions as an auxiliary memory, and an IEEE 1394 interface 14. An internal bus 15 connects the MPU 11, the memory 12, the HDD 13, and the interface 14 to one another. The MPU 11, the memory 12, and the HDD 13 define a host.

The HDD 13 stores program data executed by the MPU 11. The program data includes a typical operating system, various types of application programs, and a device driver. The program data is loaded from the HDD 13 to the memory 12.

The interface 14 is provided with a plug and play function to detect plug status changes (plug-in, plug-out) on a serial bus and issue a bus reset depending on the detection result. The other devices 2, 3, 4 also have interfaces that issue bus resets.

The interface 14 executes a predetermined bus reset sequence in response to the bus reset and stores information, which includes bus detection signals and ID packets provided from each node, in an internal buffer in time series. The bus reset sequence includes the initialization of the entire topology and the reconfiguration of the topology. When executing the bus reset sequence, the interface 14 successively analyzes information and determines whether the information has an error or is incomplete. If the information includes an error or is incomplete, the interface 14 deletes the information and re-issues the bus reset to re-execute the bus reset sequence. If the information does not include an error and is complete, the interface 14 recognizes the topology and completes the bus reset sequence. The interface 14 then provides the MPU 11 with the information that is stored in the internal buffer and required by the MPU 11.

Based on the information from the interface 14, the MPU 11 registers the information of each device, which connection has been confirmed through the bus reset, to the application software and the device driver. The registration of the information enables the application software and the device driver to recognize the devices connected to the network.

The interface 14 provides the MPU 11 with information only when the bus reset sequence is completed normally. Accordingly, the application software and the device driver do not have to process errors. This prevents the occurrence of a hangup of the software and the entire system 100 caused by a time-out or erroneous functioning.

FIG. 3 is schematic block diagram of the interface 14.

The interface 14 includes a port circuit (PORT) 21, a physical layer circuit (PHY) 22, a link layer circuit (LINK) 23, a buffer memory (MEM) 24, an interface circuit (IF) 25, and an analysis unit 26.

The port circuit 21 includes a register 21a, a first decoder 21b, and a second decoder 21c. The physical layer circuit 22 includes a register 22a and a decoder 22b, and the link layer circuit 23 includes a register 23a.

The registers 21a, 22a, 23a include information for setting the port circuit 21, the physical layer circuit 22, and the link layer circuit 23, respectively. For example, the register 21a stores variable information indicating whether the port circuit 21 is electrically connected to the port circuit of another interface or whether power is being supplied from another device.

The first decoder 21b is used for arbitration, detects information indicating external bus changes in a common mode, and decodes the detected information to generate decoded information. The decoded information is provided to the physical layer circuit 22 and the analysis unit 26.

A packet analysis decoder, second decoder 21c, decodes packets provided from other devices via an external bus and provides the decoded packets to the physical layer circuit 22 and the analysis unit 26. The register 22a stores the decoded packets.

The physical layer circuit 22 is an IEEE 1394 physical layer. The decoder 22b of the physical layer circuit 22 converts the electric signal from the port circuit 21 to a logic signal and provides the logic signal to the link layer circuit 23. The physical layer circuit 22 also converts the logic signal from the link layer circuit 23 to an electric signal and provides the electric signal to the port circuit 21.

The physical layer circuit 22 initializes external bus-related information in accordance with the information provided from the first decoder 21b and initiates the bus reset sequence. Further, the physical layer circuit 22 provides the link layer circuit 23 and the analysis unit 26 with information indicating the initiation of the bus reset sequence. The bus reset sequence initializes the information related to the bus of all of the nodes in the topology, determines a route node, determines an exclusive ID number for each node, and notifies the ID numbers to every node in the topology using packets. The physical layer circuit 22 provides the link layer circuit 23 and the analysis unit 26 with ID packets received from each node. Upon completion of the bus reset sequence, the physical layer circuit 22 provides the link layer circuit 23 and the analysis unit 26 with information indicating completion of the sequence.

An IEEE 1394 link layer, link layer circuit 23, determines whether a packet is addressed to itself from a header included at the head of the packet, and provides the buffer memory 24 with the packets addressed to the link layer circuit 23. During data transmission, the link layer circuit 23 receives packets from the MPU 11 via the buffer memory 24 and provides the packets to the physical layer circuit 22.

The buffer memory 24 temporarily stores the packets that are transmitted and received during a normal packet transfer mode, and stores the information detected along the bus during the predetermined bus reset sequence and the received packets in time series. Specifically, the buffer memory 24 is provided with information from the port circuit 21 and the physical layer circuit 22 via the analysis unit 26 and from the link layer circuit 23. The information is stored in the buffer memory 24 in time series in accordance with the bus set sequence.

The interface circuit 25 is connected to the internal bus 15 and controls the transfer of data between the MPU 11 and the interface 14.

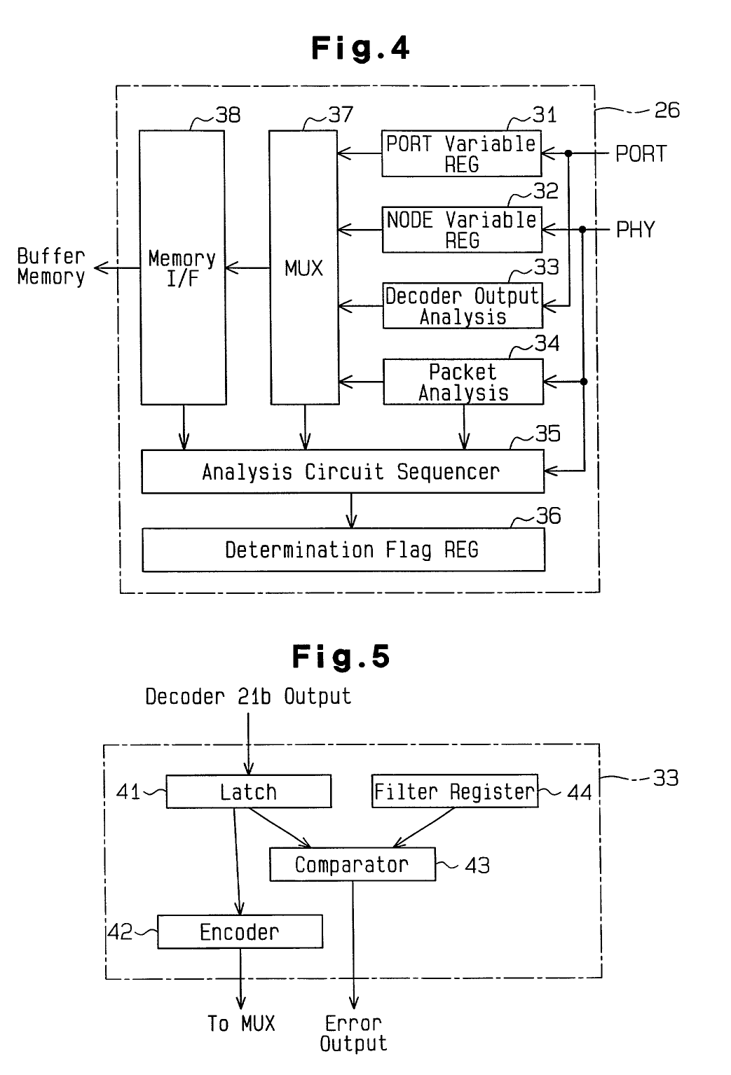

FIG. 4 is a schematic block diagram of the analysis unit 26.

The analysis unit 26 includes a port variable register 31, a node variable register 32, a decoder output analysis circuit 33, a packet analysis circuit 34, an analysis circuit sequencer 35, a determination flag register 36, a multiplexer circuit (MUX) 37, and memory interface (I/F) circuit 38.

The port variable register 31 stores internal variable information read from the register 21a of the port circuit 21. The node variable register 32 stores internal variable information read from the register 22a of the physical layer circuit 22.

The decoder output analysis circuit 33 analyzes the external bus information provided from the first decoder 21b of the port circuit 21 and provides the multiplexer circuit 37 with the external bus information and information indicating the existence of errors. The packet analysis circuit 34 analyzes the ID packets provided from the physical layer circuit 22 to detect errors and provides the multiplexer circuit 37 with the ID packets and information indicating the existence of errors.

The multiplexer circuit 37 processes the information from the registers 31, 32 and the analysis circuits 33, 34 in time series and provides the information to the memory interface circuit 38 and the analysis circuit sequencer 35. The memory interface circuit 38 controls the writing of information to the buffer memory 24.

The analysis circuit sequencer 35 analyzes the information provided in time series from the multiplexer circuit 37 in response to plug-in and plug-out information and bus reset initiation and completion signals from the physical layer circuit 22. When the analysis result indicates error-including information, the analysis circuit sequencer 35 sets an error flag of the determination flag register 36.

FIG. 5 is a schematic block diagram of the decoder output analysis circuit 33.

The decoder output circuit 33 includes a latch 41, an encoder 42, a comparator 43, and a filter register 44.

The latch 41 latches the external bus information from the first decoder 21b and provides the latched signal to the encoder 42 and the comparator 43. The encoder 42 encodes the latched signal and provides the encoded signal to the multiplexer circuit 37.

The comparator 43 compares the latched signal from the latch 41 with a predetermined sequence data signal stored in the filter register 44 and generates error information when the latched signal does not match the sequence data signal. The error information is provided to the analysis circuit sequencer 35 via the multiplexer circuit 37. In accordance with the error information, the analysis circuit sequencer 35 sets an error flag of the determination flag register 36.

When the bus reset sequence is performed optimally (normally), the decoder output analysis circuit 33 stores in the filter register 44 the same data as that sequentially stored in the register 21a of the port circuit 21 in accordance with the sequence. Alternatively, sequence data may be prestored in the filter register 44.

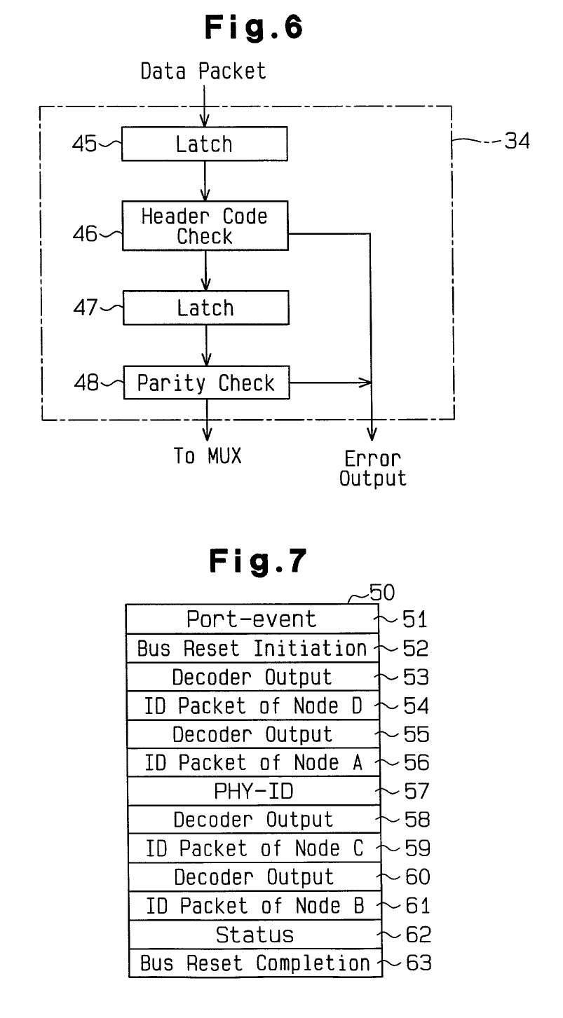

FIG. 6 is a schematic block diagram of the packet analysis circuit 34.

The packet analysis circuit 34 includes latches 45, 47, a header code check circuit 46, and a parity check circuit 48.

The latch 45 latches the data packet signal provided from the decoder 22b and provides the latched data packet signal to the header code check circuit 46. The header code check circuit 46 determines whether the code of the header added to the header of the data packet signal is a standardized code. If the code of the header is a non-standardized code, the header code check circuit 46 generates an error signal.

The latch 47 latches the error signal provided from the header code check circuit 46 and provides the latched error signal to the parity check circuit 48. The parity check circuit 48 checks whether there is a transmission error by using the parity data included in the data packet and outputs the check result.

The operation of the analysis unit 26 will now be discussed with reference to FIGS. 7 to 10.

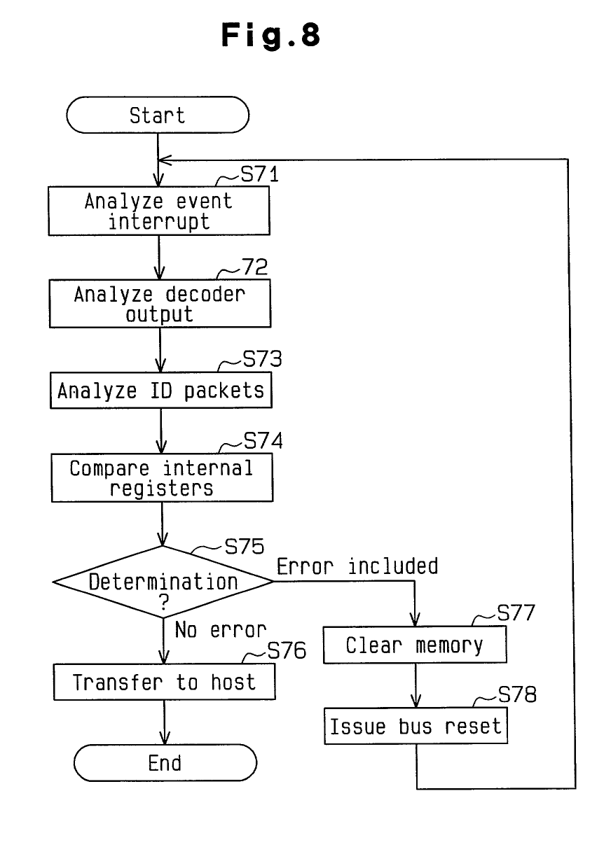

The analysis unit 26 performs an analysis process in accordance with the flowchart of FIG. 8.

First, if an interrupt event is provided to the analysis unit 26 from the physical layer circuit 22, the analysis unit 26 analyzes the interrupt event. The analysis unit 26 determines that the interrupt event is caused by a change in the variable information stored in the register of the port circuit 21 (step S71) and proceeds to the following step.

The analysis unit 26 receives the bus detection information from the first decoder 21b of the port circuit 21 and analyzes the bus detection information to determine whether the predicted bus detection information has been provided (step S72). Then, the analysis unit 26 receives ID packets from the decoder 22b of the physical layer circuit 22 and analyzes the ID packets to determine whether the ID packets include a format error (step S73). Afterward, the analysis unit 26 compares predetermined sequence data with the bus detection information stored in the register 21a of the port circuit 21 and the ID packets stored in the register 22a of the physical layer circuit 22 to determine whether the bus reset sequence is being performed normally (step S74).

The analysis unit 26 then determines whether there is an error based on the analysis result of the bus detection information and the ID packets (step S75). When an error is not included, the analysis unit 26 instructs the buffer memory 24 to transfer information to the MPU 11 upon completion of the bus reset sequence (step S76). When an error is included, the analysis unit 26 deletes the information stored in the buffer memory 24 subsequent to the initiation of the bus reset (step S77). Then, the analysis unit 26 issues a bus reset to perform the bus reset sequence again and provides an interrupt event to the MPU 11 (step S78). In step S78, instead of providing the interrupt event to the MPU 11, for example, information indicating the plug status or bus reset may be provided.

FIG. 7 is a chart illustrating the information stored in the buffer memory 24.

Information 50 is stored in memory sections 51 to 63 of the buffer memory 24 in time series and in accordance with the bus reset sequence.

The memory section 51 stores “port-event”, which indicates an interrupt event that is issued when a bus connection change is detected by the port circuit 21.

The memory section 52 stores “bus reset initiation”, and memory section 53 stores “bus reset completion”. The bus reset initiation and bus reset completion indicate the time monitored by an incorporated cycle timer.

The memory sections 53, 55, 58, 60 each store “decoder output” indicating the bus detection signal of the port circuit 21 decoded by the decoder 22b of the physical layer circuit 22.

The memory sections 54, 56, 59, 61 each store an “ID packet”, which is transmitted to the entire topology and indicate the state of each node and port. The ID packets include the ID packet of the associated interface 14. Node A corresponds to the computer 1, which is associated with the interface 14, node B corresponds to the digital VCR 2, node C corresponds to the digital camera 4, and node D corresponds to the printer 3.

The memory section 57 stores “physical ID (PHY=ID)”, which represents the physical ID of the interface 14. The memory section 62 stores “status”, which indicates the status when bus reset is completed.

The information required by the MPU 11 is bus reset initiation, bus reset completion, and the ID packet of each node. The analysis unit 26 provides the required information to the MPU 11 when the bus reset sequence is completed normally.

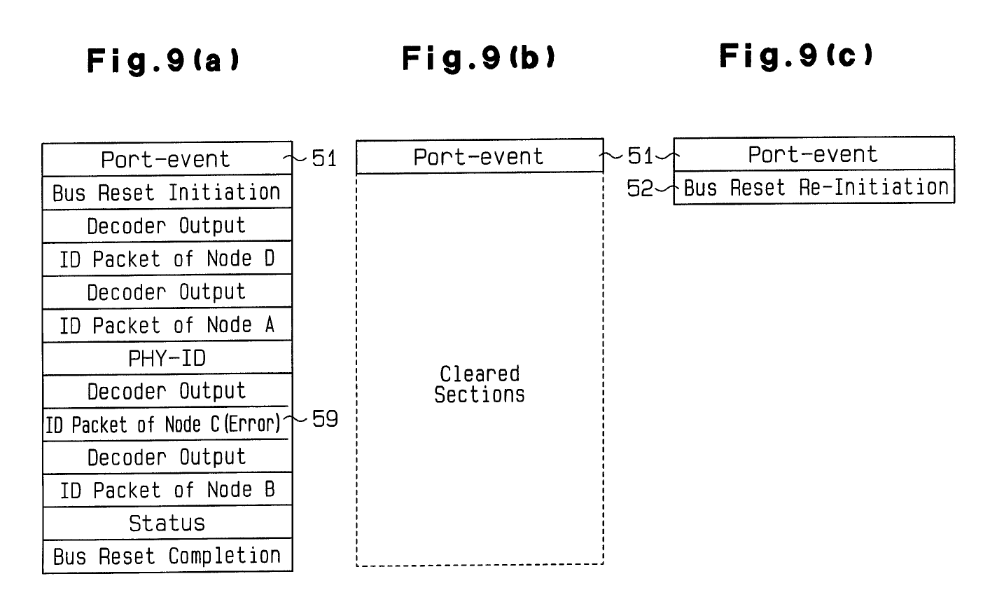

With reference to FIG. 9(a), in a first case, when an error in the ID packet of node C is detected by the decoder output analysis circuit 33 (step S72), the error flag of the determination flag register 36 is set. When the analysis unit 26 confirms the completion of the bus reset, the analysis unit 26 deletes the information stored in the buffer memory 24 subsequent to the bus reset initiation, as shown in FIG. 9(b), and issues a bus reset. The issuance of the bus reset results in the bus reset sequence being performed again. This stores the bus reset initiation information in the memory section 52, as shown in FIG. 9(c), and stores information in the buffer memory 24 in accordance with the bus reset sequence.

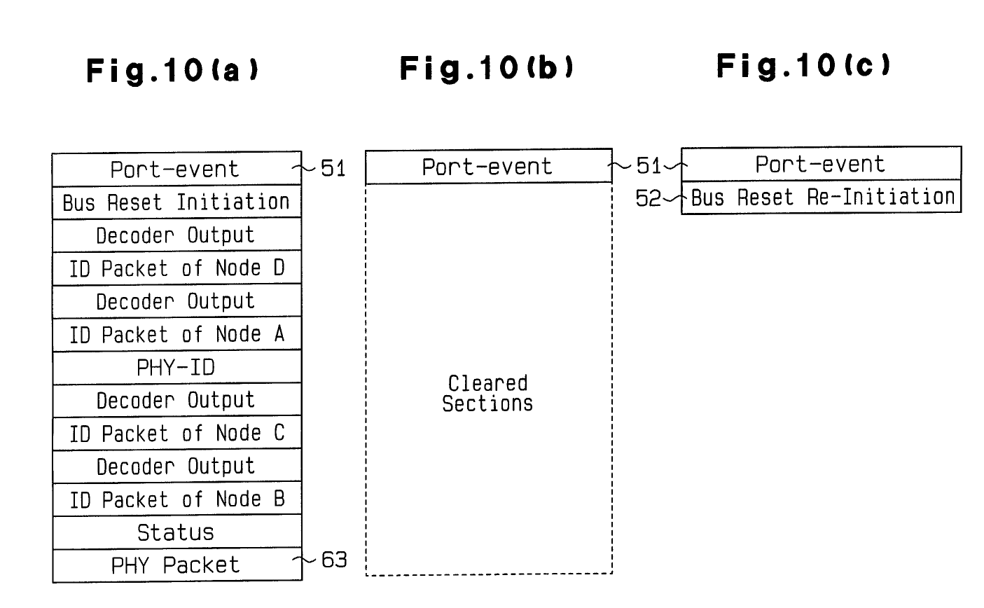

With reference to FIG. 10(a), in a second case, when another packet (PHY packet) is stored in the memory section 63 before completion of the bus reset sequence, the packet analysis circuit 34 detects an abnormality (step S73), and the error flag of the determination flag register 36 is set. The analysis unit 26 determines that the bus reset sequence has not been completed normally. Thus, the analysis unit 26 deletes the information stored in the buffer memory 24 subsequent to the bus reset, as shown in FIG. 10(b), and issues a bus reset. The issuance of the bus reset results in the bus reset sequence being performed again. This stores the bus reset initiation information in the memory section 52, as shown in FIG. 10(c), and stores information in the buffer memory 24 in accordance with the bus reset sequence.

The interface 14 of the first embodiment has the advantages described below.

(1) The analysis unit 26 analyzes information obtained from an external bus in the bus reset sequence and determines whether the bus reset sequence was completed normally. If the sequence was completed normally, the analysis unit 26 provides information to the internal bus 15 via the MPU 11. As a result, information is provided to the MPU 11 only when the bus reset sequence is completed normally. This prevents hangup of the software of the MPU 11 and the entire system.

(2) The analysis unit 26 controls the buffer memory 24 so that the MPU 11 is provided with only the required data. This reduces the data amount provided to the internal bus 15 and lightens the traffic of the internal bus 15.

(3) The analysis unit 26 generates the bus reset when abnormality is detected in the bus reset sequence. As a result, the bus reset sequence is performed again, and configuration of the topology is ensured regardless of the plug and play function.

(4) The analysis unit 26 stores bus reset sequence data in the buffer memory 24 used for normal data transmission. Thus, a new memory need not be added, and the circuit area of the interface 14 is not increased.

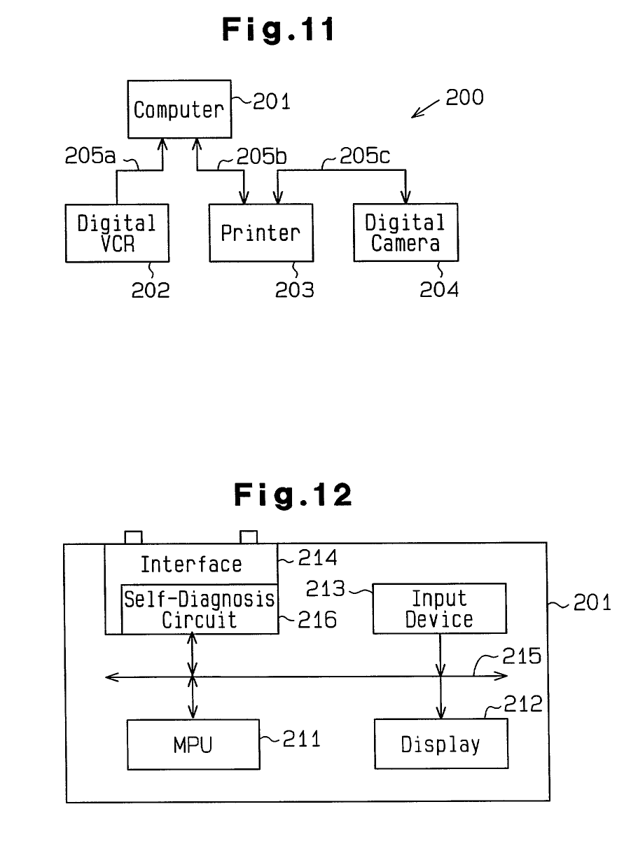

FIG. 11 is a schematic block diagram of a system 200 employing IEEE 1394 interfaces according to a second embodiment of the present invention. The system 200 includes a personal computer 201, a digital VCR 202, a printer 203, and a digital camera 204. The devices 201-204 are respectively connected to one another by IEEE 1394 bus cables 205a, 205b, 205c.

FIG. 12 is a schematic block diagram of the computer 201. The computer 201 includes a microprocessor unit (MPU) 211, a display 212, an input device 213, and an IEEE 1394 interface 214. An internal bus 215 connects the MPU 11, the display 212, the input device 213, and the interface 214 to one another.

The interface 214 includes a self-diagnosis circuit 216 to determine whether or not the interface 214 is functioning normally. When the status of the interface 214 satisfies predetermined self-diagnosis initiation requirements, the self-diagnosis circuit 216 performs diagnosis of the interface 214. When the self-diagnosis circuit 216 determines that the interface 214 is normal, the interface 214 issues a bus reset to detect the connection of devices. When the bus reset is completed in a normal manner, packet transfer is initiated.

If the interface 214 determines that the interface 214 itself has an abnormality, the interface 214 stops all or some of its functions and notifies the abnormality diagnosis result to the MPU 211 through an interrupt, or the like. The MPU 211 shows the notified self-diagnosis result on the display 212.

The interface 214 stops all or some of its operations in accordance with the location of the abnormality in the following manner.

1. When it is determined that an abnormality is included in a cable-connected port or a physical layer circuit, data cannot be transferred. By stopping the operations of the physical layer circuit and the link layer circuit, all of the operations of the interface 214 are stopped.

2. When it is determined after the interface 214 is connected to the network that some of the ports have an abnormality, the operations of the abnormal ports are stopped. This enables the transfer of data between the devices connected to the normally functioning ports and the interface 214.

3. When it is determined after the interface 214 is connected to the network that a circuit having a rank higher than the link layer circuit (in this case, the circuit of the MPU 211) has an abnormality, the operation of the link layer circuit is stopped. This stops the transfer of data between the computer 201 and the peripheral devices 202, 203, 204. In this case, the operations of the interface 214, which include the physical layer circuit, and the circuits of the peripheral devices, are allowed. This enables data transfer between the VCR 202 and the printer 203 or the camera 204 via the computer 201.

4. The IEEE 1394 interface 214 allows data transfer at multiple transfer speeds. Accordingly, when it is determined after the interface 214 is connected to the network that circuits performing high-speed data transfer have abnormalities, the operation of these circuits is stopped. In other words, the operations of low-speed data transfer circuits are enabled.

The requirements for initiating self-diagnosis include the supply of power to the interface 214, the initiation and completion of the power save mode, and the detection of a bus abnormality. The interface 214 of the computer 201 is supplied with operational power from the computer 201 or with operational power from the digital VCR 202 via the IEEE 1394 bus cable 205a or the printer 203 via the IEEE 1394 bus cable 205b.

When power is supplied, the interface 214 performs self-diagnosis and a power-on sequence.

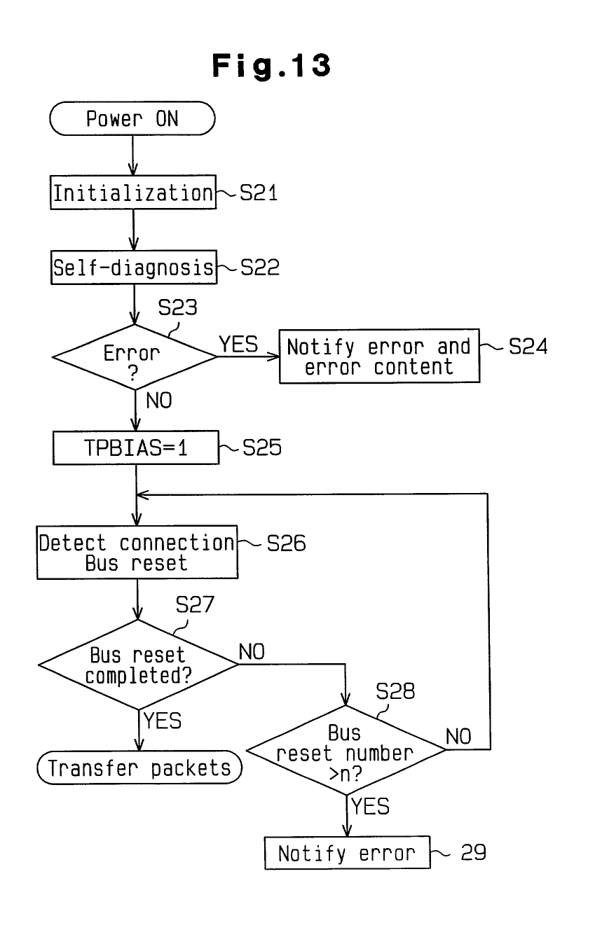

Specifically, as shown in FIG. 13, the interface 214 performs initialization in step S21. The self-diagnosis circuit 216 performs self-diagnosis initialization. When the initialization is completed, the self-diagnosis circuit 216 performs self-diagnosis in step S22.

Then, in step S23, if the self-diagnosis circuit 216 determines that there is an abnormality in the data transfer function of the interface 214, the self-diagnosis circuit 216 suspends transition to the connection procedures. In this case, the self-diagnosis circuit 216 proceeds to step S24 and notifies the MPU 211 of an error and the content of the error.

If the self-diagnosis circuit 216 determines that the data transfer function of the interface 214 is normal, the self-diagnosis circuit 216 proceeds from step S23 to step S25. In step S25, the interface 214 sets a connection recognition signal TPBIAS to 1. This indicates that data transfer between the computer 201, the digital VCR 202, and the printer 203 is enabled. For example, the interface of the digital VCR 202 receives the connection recognition signal TPBIAS from the interface 214 of the computer 201 and returns the connection recognition signal TPBIAS to the interface 214. Due to the transfer of the connection recognition signal TPBIAS, the interfaces of the computer 201 and the digital VCR 202 recognize that data transfer is possible. Thus, the computer 201 and the digital VCR 202 are electrically connected.

Next, in step S26, the interface 214 issues a bus reset to detect devices that can perform data transfer. In response to the bus reset, the interface 214 reconfigures the network topology. When the interface 214 recognizes that bus reset has been completed normally in step S27, the interface 214 initiates the transfer of packets. The interface 214 performs the connection procedures in steps S25 and S26.

If the bus reset has not been completed normally in step S27, the interface 214 proceeds from step S27 to step S28. In step S28, the interface 214 determines whether the number of times the bus reset has been issued has exceeded a predetermined n number of times. If the bus reset number has not exceeded a predetermined n number of times, the interface 214 returns to step S26 and re-issues the bus reset. If the number of bus resets has exceeded the predetermined n number of times, the interface 214 proceeds to step S29 and notifies the MPU 211 of the error. This notifies the MPU 211 that the peripheral devices 202, 203, 204 or the IEEE 1394 bus cables 205a, 205b, 205c have an abnormality although the interface 214 of the computer 201 is functioning normally.

Cases in which self-diagnosis is initiated in response to the initiation and completion of the power save mode will now be discussed.

In the power save mode, the power consumption of the computer 201 is reduced when all operations of the computer 201 or the interface 214 are unnecessary or when operations performed at predetermined frequencies are not necessary. The power save mode is initiated when the interface 214 does not transfer data for a predetermined time or longer or when the input device 213 of the computer 201 is not manipulated for a predetermined time or longer. Further, the power save mode is completed when receiving a data transfer commencement instruction, when the input device 213 is manipulated, or when there is a request for high-speed operations. When the power save mode is initiated, except for predetermined circuits, such as circuits required to restart data transfer, circuits required to restart the computer 201, and low frequency operation circuits, the supply of power is stopped. Instead of stopping the supply of power, the voltage of the supplied power may be decreased.

The interface 214 detects the initiation and completion of the power save mode and performs self-diagnosis. When detecting the initiation of the power save mode, the interface 214 performs steps S22 and S23, and if necessary, step S24 to stop the supply of power to predetermined circuits. When detecting the completion of the power save mode, the interface 214 performs steps S22 and S23, and if necessary, step S24 to restart the data transfer operation. It is preferred that the interface 214 perform self-diagnosis simultaneously to the completion of the power save mode. Further, the interface 214 may perform steps S25 to S29 as required.

Cases in which self-diagnosis is initiated in response to the detection of a bus abnormality will now be discussed.

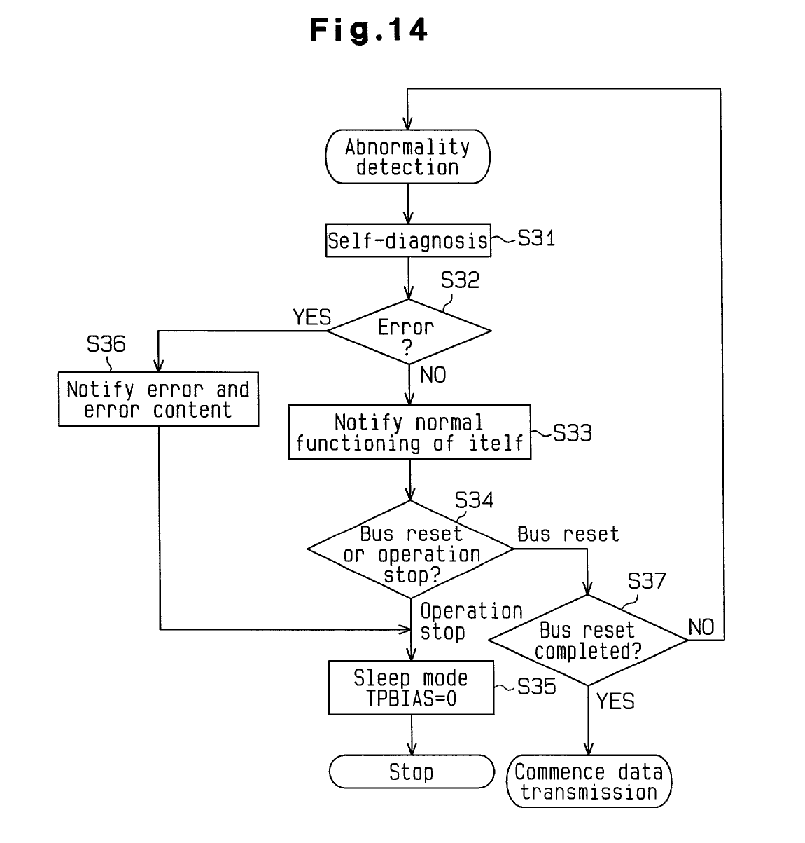

The interface 214 performs self-diagnosis in accordance with the flowchart of FIG. 14 when the self-diagnosis circuit 216 detects a bus abnormality. Bus abnormalities include continuous issuance of bus resets, continuous abnormality interrupts (continuous interrupts due to a packet CRC error, or the like), and a fixed state for over a predetermined time or longer.

In step S31, the interface 214 performs self-diagnosis. Then, in step S32, the interface 214 determines whether or not the interface 214 has an abnormality. If the interface 214 is functioning normally, the interface 214 proceeds to step S33 and notifies the MPU 211 that the interface 214 is normal. In step S34, in accordance with the content of the bus abnormality, the interface 214 chooses whether to perform a bus reset or stop operations. When a bus abnormality is detected due to the occurrence of a CRC error or a fixed state over a predetermined time or longer, a bus reset may reset the entire system. Thus, in such case, the interface 214 chooses to perform a bus reset. If a bus abnormality is detected due to the continuous issuance of bus resets, there is no possibility that the system will be reset. This, in such case, the interface 214 chooses to stop operations. In step S35, the interface 214 enters a sleep mode, resets the connection recognition signal TPBAIS to 0, and stops operations.

If the interface 214 is determined to have an abnormality in step S32, the interface 214 proceeds to step S33 and notifies the interface 214 of the error and the content of the error. Then, In S35, the interface 214 enters the sleep mode and resets the signal TPBIAS. In this manner, the interface 214 is electrically disconnected from other devices. This prevents the abnormal interface from affecting other devices.

When the interface 214 chooses to perform a bus reset in S34, the interface 214 issues a bus reset and then proceeds to step S37 to determine whether the bus reset has been completed. The interface 214 commences data transmission when the bus reset is completed. If the bus reset is not completed, the interface 214 determines that the bus has an abnormality and performs the self-diagnosis of step S31 again.

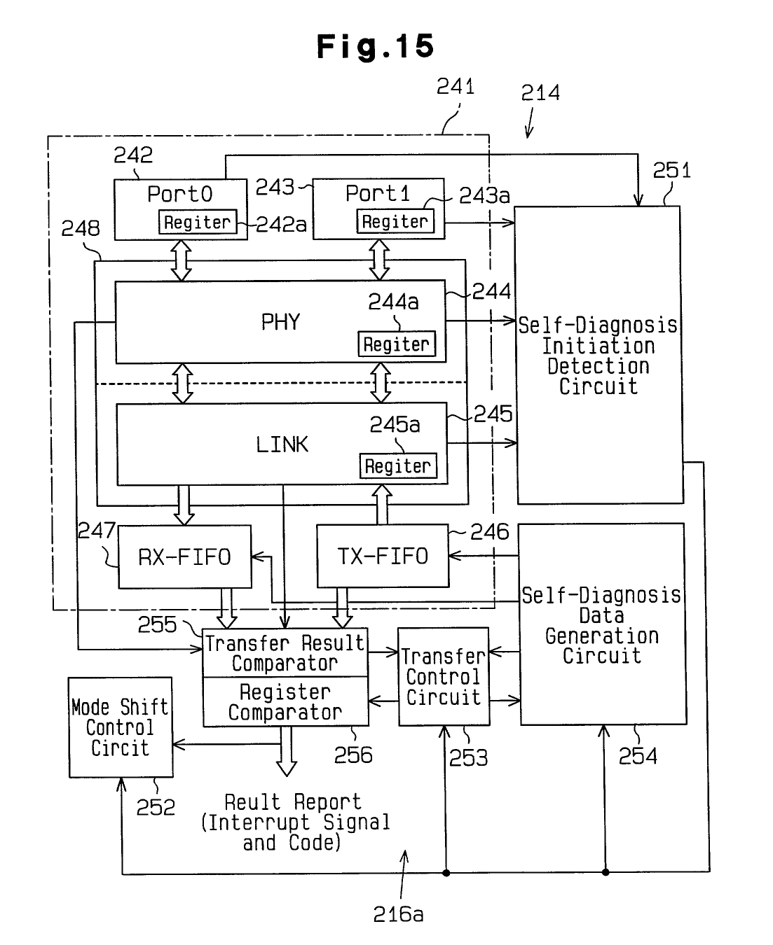

FIG. 15 is a schematic block diagram of the interface 214. The interface 214 includes a data transfer control circuit 241 and a self-diagnosis circuit 216. The data transfer control circuit 241 includes first port circuit (port 0) 242, second port circuit (port 1) 243, a physical layer circuit (PHY) 244, a link layer circuit (LINK) 245, a transmission memory (TX-FIFO) 246, and a receipt memory (RX-FIFO) 247. It is preferred that the physical layer circuit 244 and the link layer circuit 245 be formed on the same semiconductor substrate 248.

It is preferred that the first and second port circuits 242, 243 each include a driver and a receiver. Each of the first and second port circuits 242, 243 converts an internal electric signal to an electric signal complying with the IEEE 1394 bus standard when transmitting data, and converts an electric signal provided via an external cable to an internal electric signal when receiving data.

When data is being transmitted, the physical layer circuit 244 converts the logic signal (data packet) provided from the link layer circuit 245 to an electric signal and provides the electric signal to the first and second port circuits 242, 243. When data is being received, the physical layer circuit 244 provides the electric signal received from the first port circuit 242 (or the second port circuit 243) to the second port circuit 243 (or the first port circuit 242). That is, the interface 214 performs repeat data transfer. Further, the physical layer circuit 244 converts the electric signal received from the first or second port circuits 242, 243 to a logic signal (packet) and provides the logic signal to the link layer circuit 245.

The link layer circuit 245 receives the packet from the physical layer circuit 244 and analyzes the header added to the head of the packet to determine whether the packet is addressed to its associated device. Data payloaded to packets addressed to the device associated with the link layer circuit 245 is stored in the receipt memory 247. When data is being transmitted, the link layer circuit 245 generates a packet by adding the data read from the transmission memory 246 to the header and providing the packet to the physical layer circuit 244.

It is preferred that the transmission and receipt memories 246, 247 each be a first in, first out (FIFO) memory. The transmission memory 246 stores the data received from the MPU 211 and provides the data to the link layer circuit 245. The receipt memory 247 stores the data received from the link layer circuit 245 and provides the data to the MPU 211.

The first and second port circuits 242, 243, the physical layer circuit 244, and the link layer circuit 245 respectively include registers 242a, 243a, 244a, 245a for storing internal flags and set values. A data transfer route is determined based on the set value and the flag stored in each of the registers 242a-245a. Data is transmitted, received, or transferred along the data transfer route.

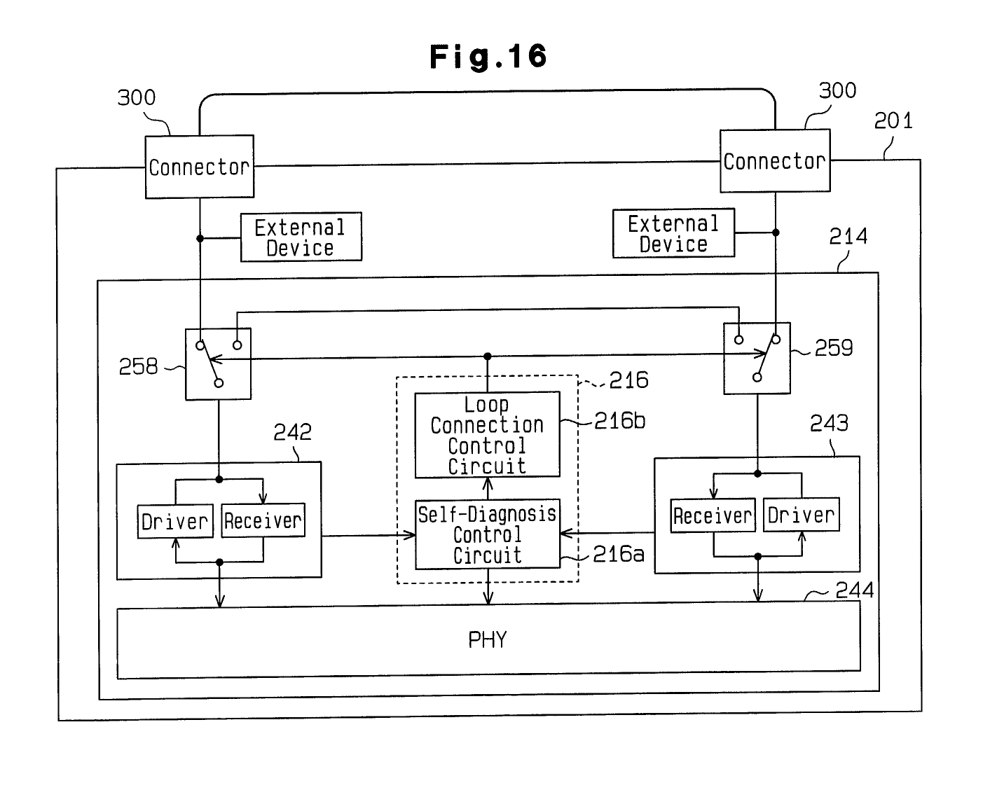

The self-diagnosis circuit 216 includes a self-diagnosis control circuit 216a and a loop connection control circuit 216b (refer to FIG. 16). The self-diagnosis control circuit 216a includes a self-diagnosis initiation detection circuit 251, a mode shift control circuit 252, a transfer control circuit 253, a self-diagnosis data generation circuit 254, a transmission result comparator 255, and a register comparator 256.

The self-diagnosis control circuit 216a detects the initiation of the self-diagnosis and shifts the data transfer control circuit 241 to a self-diagnosis mode. The self-diagnosis control circuit 216a generates the data required for self-diagnosis during the self-diagnosis mode and determines whether the interface 214 has an abnormality. The self-diagnosis control circuit 216a controls the operation of the interface 214 based on the self-diagnosis result. The loop connection control circuit 216b shifts the interface 214 between self-diagnosis and normal data transfer.

With reference to FIG. 16, two switch circuits 258, 259 are respectively connected between the port circuits 242, 243 and two connectors 300. The switch circuits 258, 259 each have a common terminal connected to the port circuits 242, 243, a first shift terminal (NV terminal) connected to the associated connector 300, and a second shift terminal (NO terminal). The second shift terminals of the switch circuits 258, 259 are connected to each other. The loop connection control circuit 216b provides the switch circuits 258, 259 with a control signal.

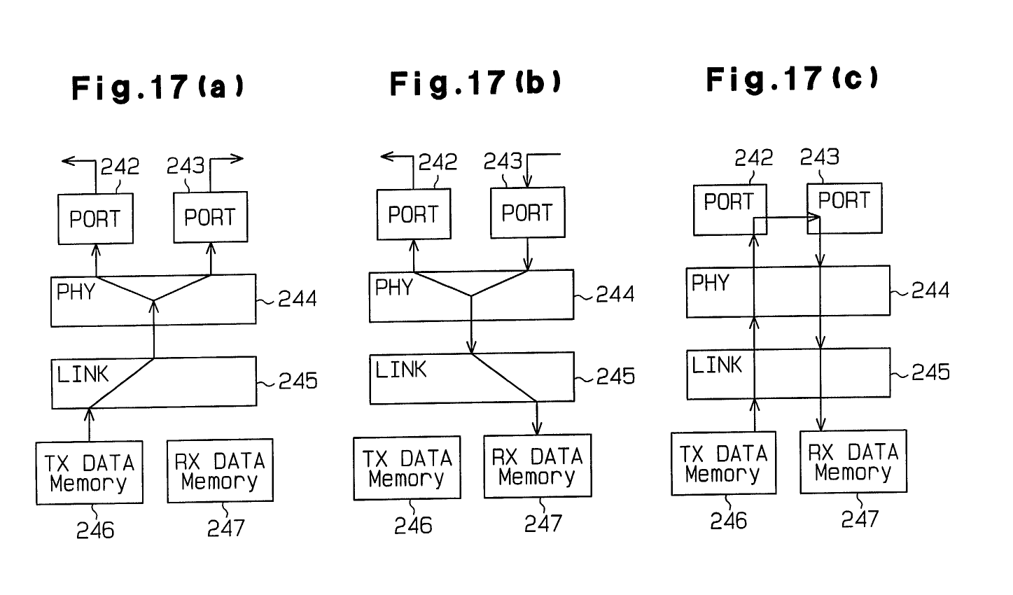

The loop connection control circuit 216b de-activates the control signal during a normal mode. In response to the de-activated control signal, the switch circuits 258, 259 electrically connect the connectors 300 to the corresponding port circuits 242, 243. In this case, as shown in FIG. 17(a), data is provided from the transmission memory 246 to the port circuits 242, 243 via the link layer circuit 245 and the physical layer circuit 244. Further, with reference to FIG. 17(b), the data provided to the second port circuit 243 is repeat transferred to the first port circuit 242 from the physical layer circuit 244. If the data is addressed to the associated device, the data is provided from the physical layer circuit 244 to the receipt memory 247 via the link layer circuit 245.

In response to the diagnosis initiation signal from the self-diagnosis control circuit 216a, the loop connection control circuit 216b enters the diagnosis mode and activates the control signal. In response to the activated control signal, the switch circuits 258, 259 connect the port circuits 242, 243 to each other. The connection enables the transfer of data in the interface 214 and starts self-diagnosis. In this case, with reference to FIG. 17(c), data is provided from the transmission memory 246 to the first port circuit 242 via the link layer circuit 245 and the physical layer circuit 244. The data is further provided from the first port circuit 242 to the receipt memory 247 via the second port circuit 243, the physical layer circuit 244, and the link layer circuit 245.

The port circuits 242, 243 are disconnected from the connectors 300 during the diagnosis mode. Thus, cables or other devices do not affect the interface 214. Accordingly, the interface 214 performs self-diagnosis without being affected by other devices. Further, for example, self-diagnosis of the computer 201 or the interface 214 may be performed during factory inspections.

The operation of the self-diagnosis circuit 216 will now be discussed.

The self-diagnosis initiation detection circuit 251 monitors the signals from the port circuits 242, 243, the physical layer circuit 244, and the link layer circuit 245 to determine whether the status of the interface 214 satisfies the self-diagnosis initiation requirements. When entering the self-diagnosis mode, that is, when the status of the interface 214 satisfies the self-diagnosis initiation requirements, the self-diagnosis initiation detection circuit 251 provides a diagnosis initiation signal to the mode shift control circuit 252, the transfer control circuit 253, the self-diagnosis data generation circuit 254, and the loop connection control circuit 216b.

In response to the diagnosis initiation signal, the mode shift control circuit 252 provides a mode shift signal to the port circuits 242, 243, the physical layer circuit 244, the link layer circuit 245, the transmission memory 246, and the receipt memory 247. This shifts the circuits 242-245 and the memories 246-247 to a diagnosis mode. In the diagnosis mode, the circuits 242-245 and the memories 246-247 transfer data with the self-diagnosis control circuit 216a. In the self-diagnosis mode, the data stored in each of the registers 242a-245a is changed.

In response to the diagnosis initiation signal, the transfer control circuit 253 generates a packet having a self-diagnosis header and provides the packet to the self-diagnosis data generation circuit 254.

The self-diagnosis data generation circuit 254 generates self-diagnosis data in response to the diagnosis initiation signal, payloads the generated data to the packet from the transfer control circuit 253, and provides the packet to the transmission memory 246. The self-diagnosis data generation circuit 254 provides the changed data to the registers 242a, 243a, 244a, 245a in which the changed data is stored. The changed data is also provided to the register comparator 256.

The packets read from the transmission memory 246 are provided to the transmission result comparator 255 and, for example, to the first port circuit 242 via the link layer circuit 245 and the physical layer circuit 244. The packets output from the first port circuit 242 are provided to the receipt memory 247 via the second port circuit 243, the physical layer circuit 244, and the link layer circuit 245. The packets read from the receipt memory 247 is provided to the transmission result comparator 255.

The transmission result comparator 255 compares the packets received from the transmission memory 246 with the packets received from the receipt memory 247 and provides the MPU 211 with a code indicating interruption and a code indicating the comparison result. The comparison result indicates whether or not the transmission memory 246, the link layer circuit 245, the physical layer circuit 244, or the port circuits 242, 243 have an abnormality.

The register comparator 256 compares the data read from the registers 242a, 243a, 244a, 245a with the data provided from the self-diagnosis data generation circuit 254 and provides the MPU 211 with a code indicating interruption and a code indicating the comparison result. The comparison result indicates whether the registers 242a-245a are functioning normally. The mode shift control circuit 252 receives comparison results from the comparators 255, 256. When an abnormality is detected during the self-diagnosis based on the comparison result, the self-diagnosis may be interrupted or continued depending on the content of the abnormality.

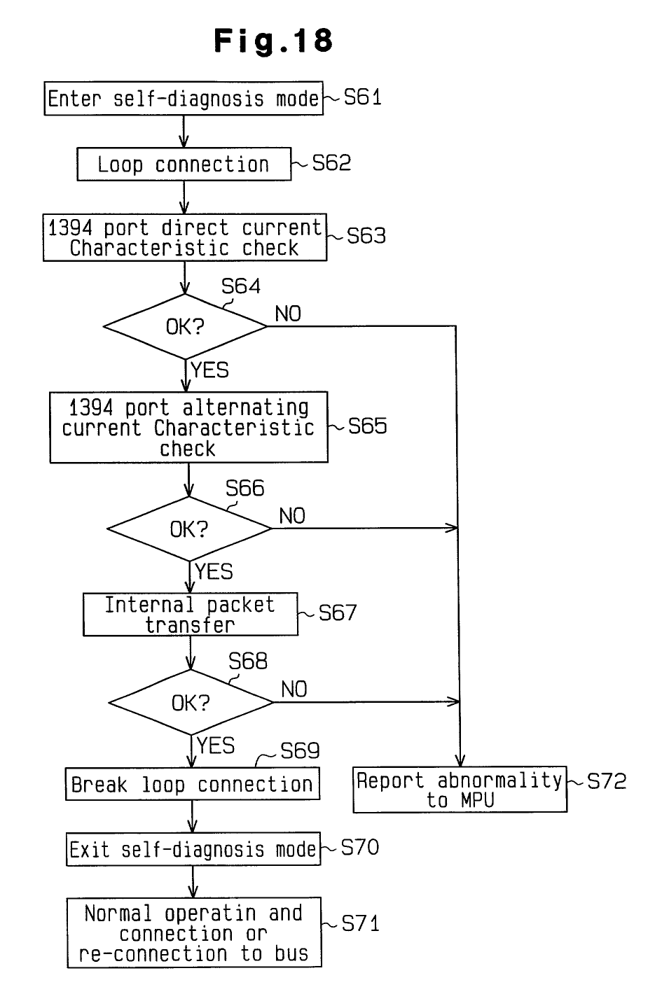

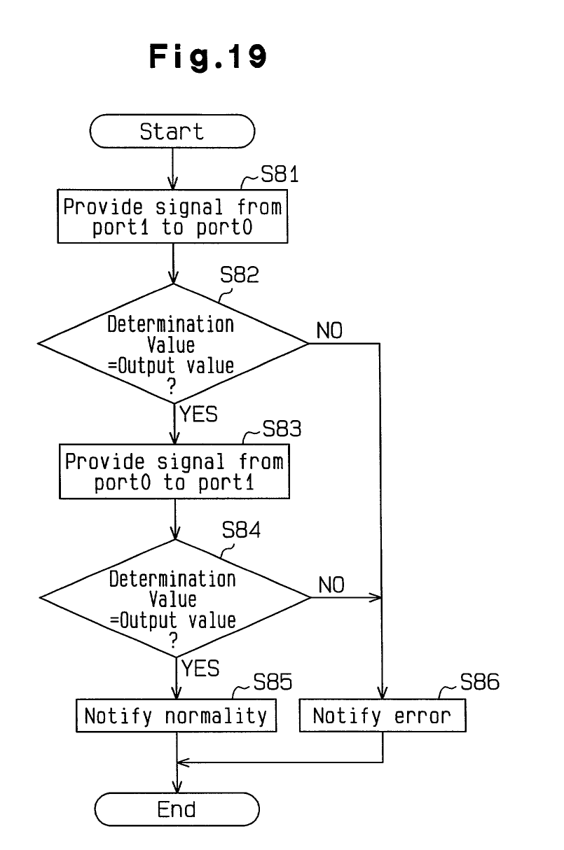

The self-diagnosis circuit 216 performs self-diagnosis in accordance with the flowchart of FIG. 18. Steps S61 to S72 of FIG. 18 are a sub-routine corresponding to step S22 of FIG. 13 (or step S31 of FIG. 14).

First, the self-diagnosis initiation detection circuit 251 enters the self-diagnosis mode if the operation state of the interface 214 satisfies the self-diagnosis initiation requirements (step S61). The loop connection control circuit 216b connects the port circuits 242, 243 to each other and forms a loop connection (step S62).

Next, the self-diagnosis circuit 216 tests the direct current characteristics of the port circuits 242, 243 (step S63). The self-diagnosis circuit 216 then determines whether the direct current characteristics of the port circuits 242, 243 are normal (step S64).

When the direct current characteristics of the port circuits 242, 243 are normal, the self-diagnosis circuit 216 tests the alternating current characteristics of the port circuits 242, 243 (step S65). The self-diagnosis circuit 216 then determines whether the alternating characteristics of the port circuits 242, 243 are normal (step S66).

When the alternating current characteristics of the port circuits 242, 243 are normal, the self-diagnosis circuit 216 starts packet transfer in the interface 214 (step S67). The self-diagnosis circuit 216 then checks whether the data transfer control circuit 241 is performing packet transfer normally (step S68).

When the packet transfer is being performed normally, the self-diagnosis circuit 216 breaks the loop connection (step S69) and causes the data transfer control circuit 241 to exit the self-diagnosis mode (step S70).

When the self-diagnosis circuit 216 determines that the interface 214 is functioning normally, the interface 214 performs normal operation and processes the bus connection or the bus re-connection (step S71).

If an abnormality is found in any one of steps S64, S66, S68, the self-diagnosis circuit 216 notifies the MPU 211 of the error and the error content (error location) (step S72).

The direct current characteristic test will now be discussed.

During the direct current characteristic test, a direct current signal is provided to the second port from the driver of the first port, and the comparator of the second port is checked whether it can correctly recognize the direct current signal. In other words, a direct current signal that is actually generated by the interface is used to test whether the interface can recognize a signal complying with the IEEE 1394 standard.

Further, during the direct current characteristic test, the self-diagnosis circuit 216 controls the first and second port circuits 242, 243 so that the driver of the first port circuit 242 provides the receiver of the second port circuit 243 with a direct current signal, and the driver of the second port circuit 243 provides the direct current signal to the receiver of the first port circuit 242.

FIG. 19 is a flowchart illustrating the direct current characteristic test, which is a sub-routine corresponding to step S63 of FIG. 18.

Determination values of a DS comparator, an ARB comparator, a port status comparator, and a speed signaling comparator are transmitted from the second port circuit 243 to the first port circuit 242 (step S81). The self-diagnosis circuit 216 compares the transmitted determination values with output values of the first port circuit 242 (step S82).

When the transmitted determination values and the output values are the same, each of the determination values are transmitted from the first port circuit 242 to the second port circuit 243 (step S83). The self-diagnosis circuit 216 then compares the transmitted determination values with the output values from the second port circuit 243 (step S84).

If the transmitted determination values and the output values are the same, the self-diagnosis circuit 216 notifies the MPU 211 that the direct current characteristic is normal (step S85). If the transmitted determination values and the output values are not the same in step S82 or S84, the self-diagnosis circuit 216 notifies the MPU 211 that the data transfer control circuit 241 has a direct current characteristic abnormality and of the direction of the transmission error (step S86).

The alternating current characteristic test will now be discussed.

During the alternating current characteristic test, the physical layer circuit 244 is employed to transfer a data signal, whose waveform is the same as that of the data used during actual data transfer, between the first and second port circuits 242, 243 and to test whether the transmitted data and the received data are the same. In other words, the alternating current characteristic test checks whether data is properly transferred at the actual transfer speed.

During the alternating current characteristic test, either one of a clock waveform signal (a signal that repeats 1 and 0) or a signal having any kind of waveform (e.g., a data packet signal generated by a link layer circuit 245) is selected.

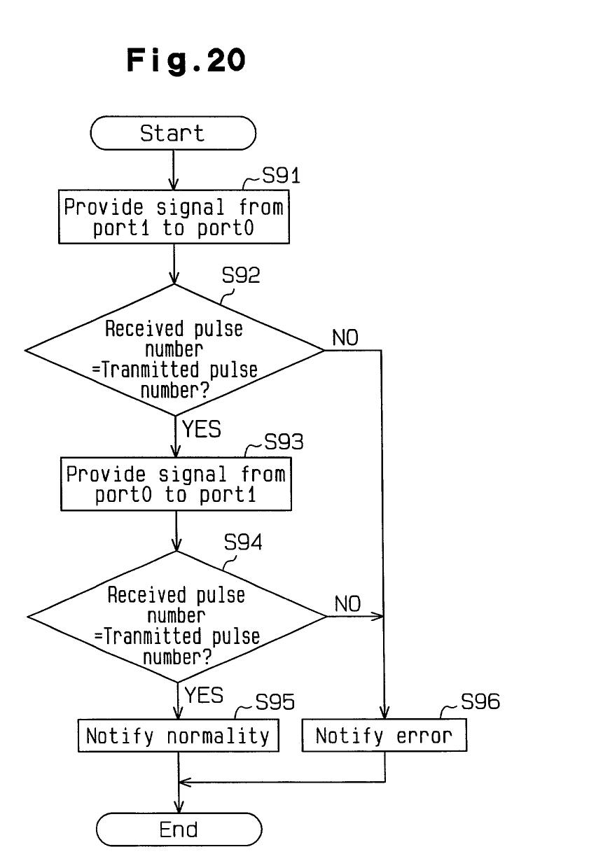

FIG. 20 is a flowchart illustrating the alternating current characteristic test, which is a sub-routine corresponding to step S65 in FIG. 18.

The self-diagnosis circuit 216 transmits a pulse signal having a predetermined frequency from the second port circuit 243 to the first port circuit 242. The self-diagnosis circuit 216 counts the number of pulses of the pulse signal received by the first port circuit 242 (step S91). Then, the self-diagnosis circuit 216 compares the pulse number of the transmitted signal with that of the received signal (step S92).

If the pulse numbers are the same, the first port circuit 242 provides the pulse signal to the second port circuit 243. The self-diagnosis circuit 216 counts the number of pulses of the pulse signal received by the second port circuit 243 (step S93). Afterward, the self-diagnosis circuit 216 compares the pulse number of the transmitted signal with that of the received signal (step S94).

If the pulse numbers are the same, the self-diagnosis circuit 216 notifies the MPU 211 that the alternating current characteristic is normal (step S95). If the pulse numbers are not the same, the self-diagnosis circuit 216 notifies the MPU 211 that the data transfer control circuit 241 has an alternating current characteristic abnormality and of the direction of the transmission error (step S96).

Interface internal packet transfer will now be discussed.

During the packet transfer, the transmitting and receiving operations using the port circuits 242, 243, the physical layer circuit 244, the link layer circuit 245, the transmission memory 246, and the receipt memory 247 are tested. Transmission packets used during data transfer and complying with the IEEE 1394 standard, transmission packets used during bus reset, and transmission packets from other nodes are employed to check the transmitting and receiving operations. The transfer control circuit 253 and the self-diagnosis data generation circuit 254 generate these packets to produce route node and non-route node environments in a pseudo-like manner.

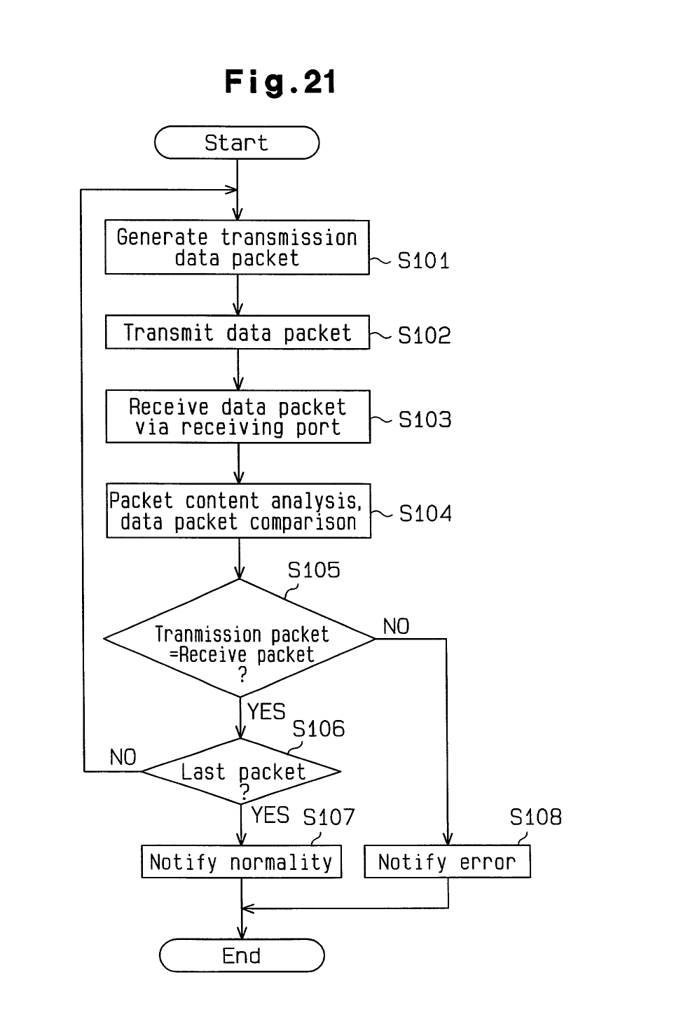

FIG. 21 is a flowchart illustrating the interface internal packet transfer, which is a sub-routine corresponding to step S67 of FIG. 18.

The self-diagnosis circuit 216 generates a transmission data packet (step S101) and transmits the transmission packet to the data transfer control circuit 241 (step S102). The transmission packet is transferred to the self-diagnosis circuit 216 as a received packet via first and second port circuits 242, 243, the physical layer circuit 244, the link layer circuit 245, the transmission memory 246, and the receipt memory 247 (step S103). The self-diagnosis circuit 216 analyzes the received packet and compares the data of the transmission packet with the data of the received packet (step S104).

If the transmission packet and the received packet are the same (step S105), the self-diagnosis circuit 216 determines whether the transmission packet is the last packet (step S106). If the last packet has not been received, the self-diagnosis circuit 216 proceeds to step S101. Steps S101 to S106 are repeated until all of the packets are transferred and compared.

When the last packet is received, the self-diagnosis circuit 216 notifies the MPU 211 that the data transfer control circuit 241 is normal (step S107). If the transmission packet does not match the received packet in step 105, the self-diagnosis circuit 216 notifies the MPU 211 that the data transfer control circuit 241 has an abnormality and of the packet having an error (step S108).

The interface 214 of the second embodiment has the advantages described below.

(1) The self-diagnosis circuit 216 performs self-diagnosis of the interface 214 and stops the interface 214 from taking connection procedures when the interface 214 has an abnormality. This prevents a deficiency of the interface 214 from affecting the entire network.

(2) When a circuit having a rank higher than the link layer circuit 245 (in this case, the circuit of the MPU 211) is abnormal, the self-diagnosis circuit 216 stops the operation of, for example, the link layer circuit 245. Accordingly, the transfer of the data of other devices via the first and second port circuits 242, 243 and the physical layer circuit 244 is enabled.

(3) The self-diagnosis circuit 216 loop connects the first and second port circuits 242, 243 and tests the data transfer control circuit 241 by transferring data from the transmission memory 246 to the receipt memory 247. Consequently, the interface 214 independently undergoes self-diagnosis before being connected to a network. This prevents an abnormal interface from being connected to a network.

(4) The self-diagnosis circuit 216 provides the MPU 211 with information indicating abnormality of the interface 214 and the content of the abnormality. The MPU 211 shows the error and the content of the error on the display 212. As a result, the occurrence of an abnormality and its content are easily confirmed.

It should be apparent to those skilled in the art that the present invention may be embodied in many other specific forms without departing from the spirit or scope of the invention. Particularly, it should be understood that the present invention may be embodied in the following forms.

a. In the first embodiment, the buffer memory 24 may temporarily store the information of the bus reset sequence, and the analysis unit 26 may analyze the information read from the buffer memory 24 after the bus reset sequence is completed. In this case, the analysis unit 26 analyzes the information at a speed slower than the speed for performing the bus reset sequence. This decreases the power consumption of the analysis unit 26.

b. In the first embodiment, in addition to the information required by the MPU 11, all or some of the information stored in the buffer memory 24 may be provided to the MPU 11. In this case, it is preferred that the number of data transfer be small. This is because the traffic in the internal bus decreases as the transfer number of the data provided to the MPU 11 decreases. Accordingly, the traffic of the internal bus 15 decreases by providing the MPU 11 with the data stored in the buffer memory 24 subsequent to data analysis.

c. In addition to an OHCI interface complying with the IEEE 1394 standard, the present invention may be applied to, for example, an interface complying with the USB standard and provided with a plug and play function.

d. In the second embodiment, the present invention is applied to an interface having two port circuits. However, the interface to which the present invention is applied may have any number of port circuits. In this case, the loop connection combination of the port circuits is changed to test the direct current and alternating current characteristics of every port.

e. In the second embodiment, the operation of the interface 214 may be stopped when the MPU 211 receives an error from the interface 214.

f. In the second embodiment, the two port circuits 242, 243 may be loop connected directly or via the loop connection control circuit 216b by employing a switch manipulated by a user.

g. In the second embodiment, diagnosis of the port circuits 242, 243, diagnosis of the transmission memory 246 and the receipt memory 247, and diagnosis of the data transfer in the interface 214 is performed. However, all of these diagnoses need not be performed as long as one is performed. Further, during the diagnosis of the port circuits 242, 243, instead of performing both direct current characteristic diagnosis and alternating current characteristic diagnosis, only one of the diagnoses may be performed.

h. In the second embodiment, data transfer in the interface 214 may be performed, for example, via the physical layer circuit 244 or the link layer circuit 245 without loop connecting the port circuits 242, 243.

i. In the second embodiment, the present invention may be applied to the interfaces of the peripheral devices 202, 203, 204. In this case, an MPU or a controller of the peripheral devices 202, 203, 204 receives a self-diagnosis result from a self-diagnosis circuit and displays error information on a displaying apparatus, such as an LCD or an LED.

j. In the second embodiment, the self-diagnosis circuit 216 may directly control the display 212 to display error information on the display 212.

The present examples and embodiments are to be considered as illustrative and not restrictive, and the invention is not to be limited to the details given herein, but may be modified within the scope and equivalence of the appended claims.

What is claimed is:

1. An interface having a plug and play function and connected to a host controller, wherein the interface performs a predetermined bus reset sequence in response to a bus reset generated by the plug and play function in accordance with a change in the status of an external bus, the interface comprising:
an analysis circuit for analyzing data provided from the external bus during the bus reset sequence and for determining whether the bus reset sequence has been completed normally, wherein the analysis circuit provides the data to the host controller when the bus reset sequence has been completed normally.

2. An interface system having a plug and play function and connected to a host controller, wherein the interface system performs a predetermined bus reset sequence in response to a bus reset generated by the plug and play function in accordance with a change in the status of an external bus, the interface system comprising:
an analysis circuit for analyzing data provided from the external bus during the bus reset sequence and determining whether the bus reset sequence has been completed normally, wherein the analysis circuit provides the data to the host controller when the bus reset sequence has been completed normally.

3. The interface system according to claim 2, wherein the analysis circuit generates the bus reset upon detecting an abnormality of the data during the data analysis.

4. The interface system according to claim 2, wherein the analysis circuit generates the bus reset upon detecting an abnormality of the data during the data analysis after providing the host controller with one of an interrupt event and necessary data.

5. The interface system according to claim 2, wherein the analysis circuit provides the host controller with necessary data.

6. The interface system according to claim 2, further comprising a buffer memory connected to the analysis circuit for storing the data provided from the external bus.

7. The interface system according to claim 6, wherein the analysis circuit stores the data in the buffer memory and simultaneously analyzes the data.

8. The interface system according to claim 6, wherein the analysis circuit analyzes the data stored in the buffer memory after storing the data in the buffer memory and after completion of the bus reset sequence.

9. The interface system according to claim 2, wherein the data includes a packet provided from an external node via the external bus in the bus reset sequence, and the analysis circuit analyzes the packet to determine whether the external bus is functioning normally.

10. The interface system according to claim 2, wherein the data includes information indicating a change in the status of the external bus, an d the analysis circuit determines whether the information corresponds to the bus reset sequence.

11. The interface system according to claim 2, further comprising:
a port circuit for detecting the status of the external bus and generating associated detection information;
a physical layer circuit connected to the port circuit to receive the data via the port circuit and generate a data packet;
a link layer circuit connected to the physical layer circuit to determine whether the data packet is addressed to the interface system; and
a buffer memory connected to the link layer circuit to store the detection information and the data packet which are provided via the port circuit, the physical layer circuit, and the link layer circuit, wherein the analysis circuit includes,
a first analysis circuit connected to the port circuit to analyze the detection information, and
a second analysis circuit connected to the physical layer circuit to analyze the data packet provided during the bus reset sequence and to determine whether the data packet is normal.

12. The interface system according to claim 11, wherein the first analysis circuit compares the detection information with predetermined sequence information, the second analysis circuit compares the data packet with a predetermined data packet, and the analysis circuit determines whether the bus reset sequence has been completed normally based on the comparison result of the first and the second analysis circuits.

13. An interface that performs a predetermined connection procedure with a network, the interface comprising:
a self-diagnosis circuit for performing self-diagnosis of the interface prior to the predetermined connection procedure, wherein the interface suspends transition to the predetermined connection procedure when the self-diagnosis circuit generates a diagnosis indicating an abnormality of the interface.

14. The interface according to claim 13, wherein the self-diagnosis circuit determines whether the status of the interface satisfies a predetermined self-diagnosis initiation requirement and initiates the self diagnosis when the self-diagnosis initiation requirement is satisfied.

15. The interface according to claim 13, wherein the predetermined connection procedure includes a bus reset sequence.

16. The interface according to claim 13, wherein the interface stops the operation of the interface and suspends transition to the predetermined connection procedure when the interface has an abnormality.

17. The interface according to claim 13, wherein the interface continues to perform the self-diagnosis of the interface after performing the predetermined connection procedure, and the interface stops operation of at least a part of the interface that does not transfer data with the network when the self-diagnosis circuit generates a diagnosis indicating an abnormality of the interface.

18. The interface according to claim 13, wherein the self-diagnosis circuit generates information when the interface has an abnormality, the information indicating the location of the abnormality.

19. The interface according to claim 13, further comprising a data transfer control circuit for performing the predetermined connection procedure and transferring data with the network, the data transfer control circuit including;
a plurality of ports connected to the network and including a first port and a second port;
a transmitting circuit connected to the plurality of ports; and
a receiving circuit connected to the plurality of ports,
wherein the self-diagnosis circuit connects the first port and the second port to each other and tests the data transfer control circuit using the data transferred from the transmitting circuit to the receiving circuit via the first and second ports.

20. The interface according to claim 19, wherein the self-diagnosis circuit includes:
a self-diagnosis control circuit for determining whether the status of the interface satisfies a predetermined self-diagnosis initiation requirement, wherein the self-diagnosis control circuit generates a self-diagnosis initiation signal and performs self-diagnosis when the predetermined self-diagnosis initiation requirement is satisfied; and
a connection control circuit connected to the self-diagnosis control circuit to connect the first and second ports to each other in response to the self-diagnosis initiation signal.

21. The interface according to claim 20, wherein the self-diagnosis control circuit includes:
a self-diagnosis initiation detection circuit for generating the self-diagnosis initiation signal when the self-diagnosis initiation requirement is satisfied;
a shift control circuit connected to the data transfer control circuit and the self-diagnosis initiation detection circuit, wherein the shift control circuit shifts the data transfer control circuit from a data transfer mode to a self-diagnosis mode;
a data generation circuit connected to the data transfer control circuit and the self-diagnosis initiation detection circuit, wherein the data generation circuit generates diagnosis data used to test the data transfer control circuit in response to the self-diagnosis initiation signal and provides the diagnosis data to the data transfer control circuit; and
a transfer data comparator connected to the data transfer control circuit and the data generation circuit, wherein the transfer data comparator compares the diagnosis data with the data transferred from the data transfer control circuit.

22. The interface according to claim 21, wherein the data transfer control circuit includes a plurality of registers, wherein the data generation circuit stores predetermined register data in the plurality of registers, and wherein the self-diagnosis circuit further includes a register data comparator for comparing the register data and the data provided from the data transfer control circuit and read from the plurality of registers.

23. The interface according to claim 19, wherein the testing of the data transfer control circuit includes at least one of a direct current characteristic test of the plurality of ports, an alternating current characteristic test of the plurality of ports, and a data transfer test of the data transfer control circuit.

24. A self-diagnosis method employed by an interface that performs a predetermined connection procedure with a network, wherein the interface has a plurality of ports, a transmitting circuit, and a receiving circuit, the plurality of ports including a first port and a second port, and the transmitting and receiving circuit each being connected to the plurality of ports, the self-diagnosis method comprising the steps of:
connecting the first and second ports to each other prior to the predetermined connection procedure;
transferring data from the transmitting circuit to the receiving circuit via the first and second ports; and
comparing data transmitted by the transmitting circuit and data received by the receiving circuit.

25. The self-diagnosis method according to claim 24, further comprising the step of:
testing a direct current characteristic of the plurality of ports by transferring direct current signals between the first and second ports.

26. The self-diagnosis method according to claim 24, further comprising the step of:
testing an alternating current characteristic of the plurality of ports by transferring direct current signals between the first and second ports.

27. The self-diagnosis method according to claim 24, further comprising the step of:
determining whether the status of the interface satisfies a predetermined self-diagnosis initiation requirement, wherein the connecting step is performed when the self-diagnosis initiation requirement is satisfied.

28. The self-diagnosis method according to claim 24, wherein the predetermined connection procedure includes a bus reset sequence.

29. The self-diagnosis method according to claim 24, further comprising the steps of:
determining whether the interface has an abnormality based on a result of the comparing step; and
suspending transition to the predetermined connection procedure when the interface is determined to have an abnormality.

30. The self-diagnosis method according to claim 29, further comprising the step of:
generating information when the interface has an abnormality, the information indicating the location of the abnormality.

31. The self-diagnosis method according to claim 24, further comprising the steps of:
detecting whether the network has an abnormality after the predetermined connection procedure is performed;
performing the connecting step, the transferring step, and the comparing step when an abnormality of the network is detected;
determining whether the interface has an abnormality based on a result of the comparing step; and
stopping operation of a part of the interface that does not transfer data with the network when the interface is determined to have an abnormality.
